(19) United States
(12) Patent Application Publication
(10) Pub. No.: US 2025/0159610 A1
(43) Pub. Date: May 15, 2025

(54) METHOD AND APPARATUS FOR TRANSMITTING WAKE-UP SIGNAL, AND READABLE STORAGE MEDIUM

(71) Applicant: Beijing Xiaomi Mobile Software Co., Ltd., Beijing (CN)

(72) Inventor: Ting FU, Beijing (CN)

(73) Assignee: Beijing Xiaomi Mobile Software Co., Ltd., Beijing (CN)

(21) Appl. No.: 18/839,144

(22) PCT Filed: Feb. 24, 2022
(86) PCT No.: PCT/CN2022/077767

§ 371 Date: Aug. 16, 2024

(51) Int. Cl. H04W 52/02; H04L 27/26; H04W 72/0453

(52) U.S. Cl. CPC H04W 52/0235; H04L 27/26025; H04W 72/0453

(57) ABSTRACT

The present disclosure is applied to the technical field of wireless communications. Provided are a method and apparatus for transmitting a wake-up signal, and a readable storage medium. The method comprises: a user equipment receiving a wake-up signal according to a subcarrier spacing, wherein the subcarrier spacing is a subcarrier spacing of a synchronization signal block. By means of the present disclosure, after a user equipment receives a synchronization signal block by using a subcarrier spacing corresponding to the synchronization signal block and completes synchronization, there is no need to adjust a baseband parameter, and a baseband parameter corresponding to the subcarrier spacing is directly used to receive or process a wake- up signal, thus effectively reducing the processing complexity of the user equipment receiving the wake-up signal, and reducing the power consumption of the user equipment.

### TECHNICAL FIELD

The present disclosure relates to the field of wireless communication technologies, and particularly to a method and an apparatus for transmitting a wake up signal, and a readable storage medium.

### BACKGROUND

In wireless communication technologies, such as a 5th generation (5G) mobile communication technology, a main transceiver may be made to enter a sleep state in order to save power consumption of a user equipment (UE).

A network device may send a wake up signal (WUS) to the UE, the WUS may indicate to one or more UEs whether to wake up for downlink monitoring. The WUS signal corresponds to a separate transceiver. The UE processes downlink data and uplink data by using the main transceiver. In an example, the WUS includes 16 bits corresponding to 16 UEs, and each bit corresponds to one UE. A bit corresponding to one of the UEs being 1 indicates to wake up, and this UE turns on the main transceiver for receiving a downlink signal; and a bit corresponding to this UE being 0 indicates not to wake up, and this UE maintains the main transceiver in the sleep state.

How to reduce complexity of receiving the wake up signal by the UE is a problem to be solved.

### SUMMARY

The present disclosure provides a method and an apparatus for receiving a wake up signal, and a readable storage medium.

In a first aspect, a method for receiving a wake up signal is provided. The method is performed by a UE, and includes:
receiving the wake up signal based on a subcarrier spacing, where the subcarrier spacing is a subcarrier spacing of a synchronizing signal block.

In this method, the UE receives the wake up signal based on the subcarrier spacing, where the subcarrier spacing is a subcarrier spacing of the synchronizing signal block, enabling the UE, after receiving the synchronizing signal block and performing synchronization, to receive the wake up signal based on the same subcarrier spacing without the need for software adjustment and hardware adjustment, thereby effectively reducing complexity of receiving the wake up signal by the UE, and saving the UE's power consumption.

In some possible embodiments, the subcarrier spacing is obtained based on agreement of protocol.

In some possible embodiments, the method further includes:
receiving configuration information sent by a network device, where the configuration information is used for configuring a frequency-domain position corresponding to the wake up signal;
where the receiving the wake up signal based on the subcarrier spacing includes:
receiving, at the frequency-domain position, the wake up signal based on the subcarrier spacing.

In some possible embodiments, the frequency-domain position corresponding to the wake up signal is one of:
a frequency-domain position corresponding to the synchronizing signal block;
a frequency-domain position corresponding to a control resource set CORESET #0;
a frequency-domain position corresponding to an initial bandwidth part; and
all or part of frequency-domain positions corresponding to an active bandwidth part.

In some possible embodiments, a center location of the frequency-domain position corresponding to the wake up signal is one of:
a center location of a frequency-domain position corresponding to the synchronizing signal block; and
a center location of a frequency-domain position corresponding to a control resource set CORESET #0.

In some possible embodiments, the receiving the wake up signal based on the subcarrier spacing includes:
receiving, in a secondary cell, the wake up signal based on the subcarrier spacing, where the frequency-domain position corresponding to the wake up signal is a frequency-domain position corresponding to a first active bandwidth part.

In some possible embodiments, an end location of a frequency-domain position corresponding to the wake up signal is provided with a frequency-domain guard interval.

In some possible embodiments, the frequency-domain guard interval is obtained based on agreement of protocol.

In some possible embodiments, indication information sent by a network device is received, where the indication information is used for indicating the frequency-domain guard interval.

In a second aspect, a method for sending a wake up signal is provided. The method is performed by a network device, and includes:
sending, based on a subcarrier spacing, the wake up signal, where the subcarrier spacing is a subcarrier spacing of a synchronizing signal block.

In this method, the network device configures the frequency-domain position corresponding to the wake up signal and sends the wake up signal based on the subcarrier spacing, and the UE receives the wake up signal based on the subcarrier spacing, where the subcarrier spacing is a subcarrier spacing of the synchronizing signal block, enabling the UE, after receiving the synchronizing signal block and performing synchronization, to receive the wake up signal based on the same subcarrier spacing without the need for software adjustment and hardware adjustment, thereby effectively reducing complexity of receiving the wake up signal by the UE, and saving the UE's power consumption.

In some possible embodiments, the method further includes:
obtaining the subcarrier spacing based on agreement of protocol.

In some possible embodiments, the method further includes:
sending configuration information to the UE, where the configuration information is used for configuring a frequency-domain position corresponding to the wake up signal;
where the sending, based on the subcarrier spacing, the wake up signal to the UE includes:
sending to the UE, at the frequency-domain position, the wake up signal based on the subcarrier spacing.

In some possible embodiments, the frequency-domain position corresponding to the wake up signal is one of:
a frequency-domain position corresponding to the synchronizing signal block;
a frequency-domain position corresponding to a control resource set CORESET #0;
a frequency-domain position corresponding to an initial bandwidth part; and
all or part of frequency-domain positions corresponding to an active bandwidth part.

In some possible embodiments, a center location of the frequency-domain position corresponding to the wake up signal is one of:
a center location of a frequency-domain position corresponding to the synchronizing signal block; and
a center location of a frequency-domain position corresponding to a control resource set CORESET #0.

In some possible embodiments, the sending the wake up signal based on the subcarrier spacing includes:
sending, in a secondary cell, the wake up signal based on the subcarrier spacing, where the frequency-domain position corresponding to the wake up signal is a frequency-domain position corresponding to a first active bandwidth part.

In some possible embodiments, an end location of a frequency-domain position corresponding to the wake up signal is provided with a frequency-domain guard interval.

In some possible embodiments, the method further includes:
obtaining the frequency-domain guard interval based on agreement of protocol.

In some possible embodiments, the method further includes:
sending indication information to the UE, where the indication information is used for indicating the frequency-domain guard interval.

In a third aspect, a communication device is provided. The communication device may be configured to perform steps performed by the UE in the first aspect described above or in any of the possible designs of the first aspect. The UE may implement the functions in the above methods by means of a hardware structure, a software module, or a hardware structure plus a software module.

In implementing the communication device shown in the first aspect by means of a software module, the communication device may include a transceiver module.

The transceiver module is configured to receive the wake up signal based on a subcarrier spacing, where the subcarrier spacing is a subcarrier spacing of a synchronizing signal block.

In a fourth aspect, a communication device is provided. The communication device may be configured to perform steps performed by the network device in the second aspect described above or in any of the possible designs of the second aspect. The network device may implement the functions in the above methods by means of a hardware structure, a software module, or a hardware structure plus a software module.

In implementing the communication device shown in the second aspect by means of a software module, the communication device may include a transceiver module.

The transceiver module is configured to send the wake up signal based on a subcarrier spacing, where the subcarrier spacing is a subcarrier spacing of a synchronizing signal block.

In a fifth aspect, a communication device is provided. The communication device includes a processor and a memory. The memory is configured to store a computer program. The processor is configured to execute the computer program, thereby implementing the first aspect or any of the possible designs of the first aspect.

In a sixth aspect, a communication device is provided. The communication device includes a processor and a memory. The memory is configured to store a computer program. The processor is configured to execute the computer program, thereby implementing the second aspect or any of the possible designs of the second aspect.

In a seventh aspect, a computer-readable storage medium is provided. The computer-readable storage medium stores an instruction (or referred to as a computer program or a program) that, when invoked and executed on a computer, enables the computer to perform the first aspect or any of the possible designs of the first aspect.

In an eighth aspect, a computer-readable storage medium is provided. The computer-readable storage medium stores an instruction (or referred to as a computer program or a program) that, when invoked and executed on a computer, enables the computer to perform the second aspect or any of the possible designs of the second aspect.

It should be understood that the above general description and the subsequent detailed description are exemplary and explanatory only, and do not limit the present disclosure.

### BRIEF DESCRIPTION OF THE DRAWINGS

The accompanying drawings illustrated herein are used for providing a further understanding of the embodiments of the present disclosure and form part of the present application, and the schematic embodiments of the embodiments of the present disclosure and their illustrations are used for explaining the embodiments of the present disclosure and do not constitute an undue limitation on the embodiments of the present disclosure. In the accompanying drawings:

The accompanying drawings herein are incorporated into the specification and form a part of the specification, illustrating embodiments in accordance with the embodiments of the present disclosure and used together with the specification to explain principles of the embodiments of the present disclosure.

FIG. 1 is a schematic diagram of an architecture of a wireless communication system provided by an embodiment of the present disclosure;

FIG. 2 is a flowchart of a method for transmitting a wake up signal illustrated according to an embodiment;

FIG. 3 is a flowchart of a method for transmitting a wake up signal illustrated according to an embodiment;

FIG. 4 is a flowchart of a method for transmitting a wake up signal illustrated according to an embodiment;

FIG. 5 is a flowchart of a method for transmitting a wake up signal illustrated according to an embodiment;

FIG. 6 is a structural diagram of an apparatus for sending a wake up signal illustrated according to an embodiment;

FIG. 7 is a structural diagram of an apparatus for sending a wake up signal illustrated according to an embodiment;

FIG. 8 is a structural diagram of an apparatus for receiving a wake up signal illustrated according to an embodiment;

FIG. 9 is a structural diagram of an apparatus for receiving a wake up signal illustrated according to an embodiment.

### DETAILED DESCRIPTION

The embodiments of the present disclosure are further described in connection with the accompanying drawings and the DETAILED DESCRIPTION.

The exemplary embodiments are described in detail here, examples of which are indicated in the accompanying drawings. When the following description involves the accompanying drawings, the same numerals in different accompanying drawings indicate the same or similar elements unless otherwise indicated. The embodiments described in the following exemplary embodiments do not represent all embodiments consistent with the embodiments of the present disclosure. On the contrary, they are only examples of devices and methods consistent with some aspects of the present disclosure as detailed in the appended claims.

The terms used in the embodiments of the present disclosure are used solely for the purpose of describing particular embodiments, and are not intended to limit the embodiments of the present disclosure. The singular forms of “a” and “the” used in the embodiments of the present disclosure and the appended claims are also intended to include the majority form, unless the context clearly indicates other meanings. It should also be understood that the term “and/or” as used in this article refers to and includes any or all possible combinations of one or more of the associated listed items.

It should be understood that although the terms first, second, and third, etc. may be used in the embodiments of the present disclosure to describe various types of information, such information should not be limited to these terms. These terms are only used to distinguish the same type of information from one another. For example, without departing from the scope of the embodiments of the present disclosure, the first information may also be referred to as the second information, and similarly, the second information may also be referred to as the first information. Depending on the context, the phrase “if” and “in case” as used herein may be interpreted as “at the time of . . . ”, “when . . . ”, or “in response to determining”.

The embodiments of the present disclosure are described in detail below, and examples of the embodiments are shown in the accompanying drawings, where the same or similar symbols throughout indicate the same or similar elements. The embodiments described below with reference to the accompanying drawings are exemplary and are intended to be used for explaining the present disclosure, and should not be construed as limitations on the present disclosure.

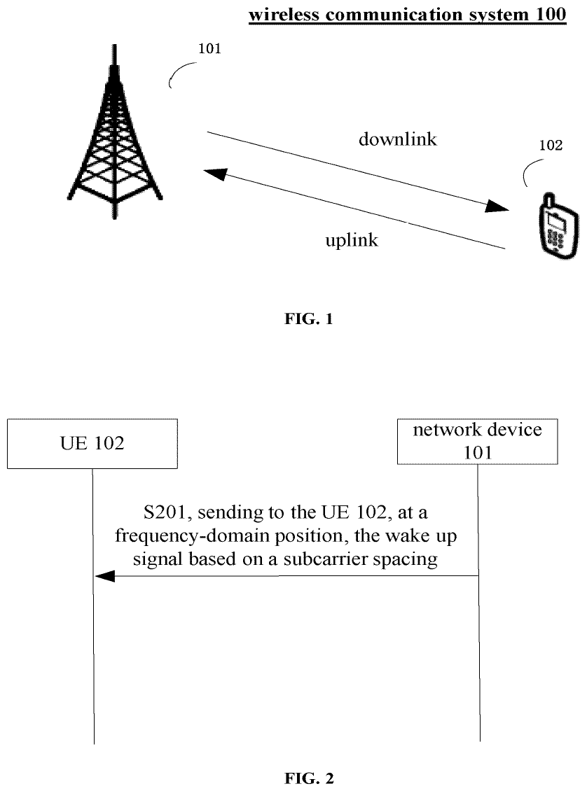

As shown in FIG. 1, a method for transmitting a wake up signal provided by the embodiments of the present disclosure may be applied to a wireless communication system 100. The wireless communication system 100 may include, but be not limited to, a network device 101 and a UE 102. The UE 102 is configured to support carrier aggregation, and the UE 102 may be connected to a plurality of carrier units of the network device 101, where the plurality of carrier units include a primary carrier unit and one or multiple secondary carrier units.

It should be understood that the wireless communication system 100 may be applicable to both low frequency and high frequency scenarios. Application scenarios of the wireless communication system 100 include, but are not limited to, a long term evolution (LTE) system, an LTE frequency division duplex (FDD) system, an LTE time division duplex (TDD) system, a worldwide interoperability for microwave access (WiMAX) communication system, a cloud radio access network (CRAN) system, a future 5th-generation (5G) system, a new radio (NR) communication system or a future evolution public land mobile network (PLMN) system, etc.

The UE 102 shown above may be a user equipment, a terminal, an access terminal, a terminal unit, a terminal station, a mobile station (MS), a remote station, a remote terminal, a mobile terminal, a wireless communication device, a terminal agent, or a user device, etc. The UE 102 may have a wireless transceiving function, and be capable of communicating (e.g., wirelessly communicating) with one or more network devices 101 of one or more communication systems, and accepting network service provided by the network device 101, where the network device 101 herein includes, but is not limited to, the base station illustrated in the drawing.

In some embodiments, the UE 102 may be a cellular phone, a cordless phone, a session initiation protocol (SIP) phone, a wireless local loop (WLL) station, a personal digital assistant (PDA) device, a handheld device with a wireless communication capability, a computing device or other processing device connected to a wireless modem, an in-vehicle device, a wearable device, a user device in a future 5G network, or a user device in a future evolution PLMN network, etc.

The network device 101 may be an access network device (or referred to as an access network site). In some embodiments, the access network device refers to a device providing a network access function, such as a radio access network (RAN) base station. The network device may specifically include a base station (BS) device, or include the base station device and a radio resource management device configured to control the base station device. The network device may further include a relay station (a relay device), an access point, and a base station in the future 5G network, a base station in the future evolution PLMN network, or an NR base station, etc. The network device may be a wearable device or an in-vehicle device. The network device may also be a communication chip with a communication module.

For example, the network device 101 includes, but is not limited to, a next-generation base station (gnodeB, gNB) in 5G, an evolved node B (eNB) in the LTE system, a radio network controller (RNC), a node B (NB) in a wideband code division multiple access (WCDMA) system, a radio controller under the CRAN system, a base station controller (BSC), a base transceiver station (BTS) in a global system for mobile communication (GSM) system or a code division multiple access (CDMA) system, a home base station (for example, a home evolved nodeB, or a home node B (HNB)), a baseband unit (BBU), a transmitting and receiving point (TRP), a transmitting point (TP), or a mobile switching center.

In order to enable a main transceiver of a UE to keep asleep for a long period of time when the UE is in an RRC idle state or an RRC connected state, a separate receiver corresponding to a WUS needs to complete a synchronization function. When the synchronization is performed, the synchronization may be performed either by listening to a synchronizing signal block (SSB) or by using a characteristic that the WUS itself has a synchronization function.

Therefore, a frequency-domain characteristic of the WUS needs to be designed in order to reduce complexity of receiving the WUS by the UE.

The embodiments of the present disclosure provide a method for transmitting a wake up signal. FIG. 2 is a flowchart of a method for transmitting a wake up signal illustrated according to an embodiment. As shown in FIG. 2, the method includes step S201.

At step S201, a network device 101 sends, based on a subcarrier spacing, a wake up signal to a UE 102.

The subcarrier spacing corresponding to the wake up signal sent by the network device 101 to the UE 102 is a subcarrier spacing of a synchronizing signal (SS)/physical broadcast channel (PBCH) block. The UE 102 receives the wake up signal based on the subcarrier spacing.

In an embodiment of the present application, the network device 101 obtains, based on agreement of protocol, the subcarrier spacing used for sending the wake up signal to the UE 102, and the UE 102 obtains, based on the agreement of the protocol, the subcarrier spacing used for receiving the wake up signal sent by the network device 101. That is, there is no need to negotiate which subcarrier spacing to use for transmitting the wake up signal between the network device and the UE, and they both can use the subcarrier spacing agreed in the protocol separately.

For example, if the subcarrier spacing agreed in the protocol for the wake up signal is 15 KHz, the network device sends the wake up signal to the UE 102 by using 15 KHz, and the UE 102 receives, by using 15 KHz, the wake up signal sent by the network device 101.

In the embodiment of the present disclosure, the network device 101 sends, based on the subcarrier spacing, the wake up signal to the UE 102, and the subcarrier spacing is a subcarrier spacing of the synchronizing signal block. This may enable the UE 102, after receiving, by using the subcarrier spacing corresponding to the synchronizing signal block, the synchronizing signal block and completing synchronization, to directly use, without the need for adjustment of a baseband parameter, the baseband parameter corresponding to this subcarrier spacing to receive or process the wake up signal, thereby effectively reducing processing complexity of receiving the wake up signal by the UE, and saving the UE's power consumption.

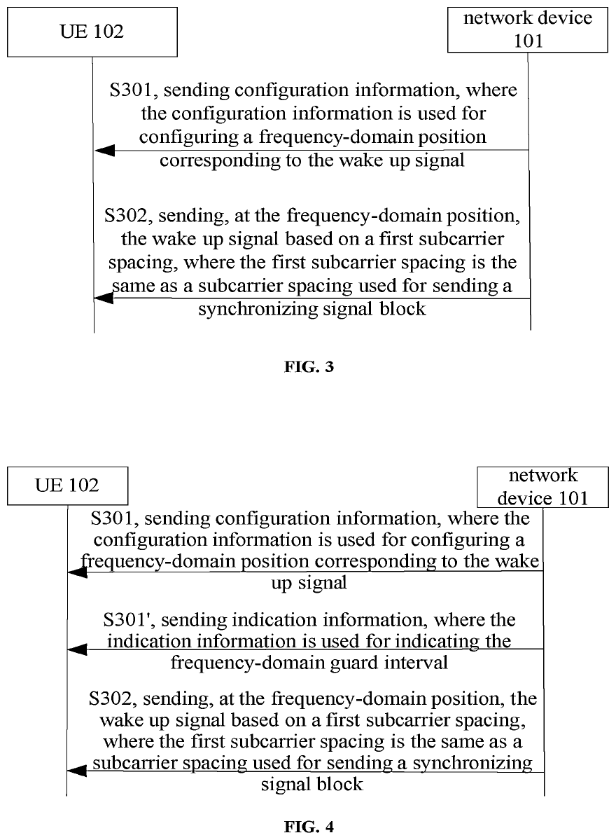

The embodiments of the present disclosure provide a method for transmitting a wake up signal. FIG. 3 is a flowchart of a method for transmitting a wake up signal illustrated according to an embodiment. As shown in FIG. 3, the method includes steps S301 to S302.

At step S301, a network device 101 sends configuration information to a UE 102.

The configuration information sent by the network device to the UE is used for configuring a frequency-domain position corresponding to the wake up signal. After receiving the configuration information, the UE obtains the frequency-domain position corresponding to the wake up signal. The frequency-domain position corresponding to the wake up signal is one of:
a frequency-domain position corresponding to the synchronizing signal block;
a frequency-domain position corresponding to a control resource set CORESET #0;
a frequency-domain position corresponding to an initial bandwidth part (BWP); and
all or part of frequency-domain positions corresponding to an active BWP.

In an embodiment of the present application, the frequency-domain position corresponding to the wake up signal is a frequency-domain position corresponding to the synchronizing signal block. This enables the UE 102 in an RRC idle state, after receiving, by using the frequency-domain position corresponding to the synchronizing signal block, the synchronizing signal block and completing synchronization based on the synchronizing signal block, to continue to receive the wake up signal by using this frequency-domain position without the need for adjustment of a radio frequency (RF) processing parameter, thereby reducing processing complexity of receiving the wake up signal by the UE.

In an embodiment of the present application, the frequency-domain position corresponding to the wake up signal is a frequency-domain position corresponding to a control resource set CORESET #0. This enables the UE 102 in the RRC idle state, after receiving a synchronizing signal and completing the synchronization, and receiving downlink control information (DCI) in CORESET #0 by using the frequency-domain position corresponding to CORESET #0, to continue to receive the wake up signal by using this frequency-domain position without the need for adjustment of the RF processing parameter.

Optionally, the frequency-domain position corresponding to the wake up signal may be a frequency-domain position corresponding to an initial BWP. This enables the UE 102 in the RRC idle state, after receiving the synchronizing signal and receiving a system message on the initial BWP, to continue to receive the wake up signal by using this frequency-domain position without the need for adjustment of the RF processing parameter.

Exemplarily, the frequency-domain position corresponding to the wake up signal may also be all of frequency-domain positions corresponding to an active BWP, i.e., the frequency-domain position corresponding to the wake up signal is the frequency-domain position corresponding to the active BWP. This allows the UE 102 in an RRC connected state, after receiving downlink information on the active BWP, to continue to receive the wake up signal by using this frequency-domain position without the need for adjustment of the RF processing parameter and without the need for switching of the bandwidth part.

In an embodiment of the present application, the frequency-domain position corresponding to the wake up signal is part of frequency-domain positions corresponding to an active BWP. This allows the UE 102 in the RRC connected state, after receiving the downlink information at part of frequency-domain positions corresponding to the active BWP, to continue to receive the wake up signal by using this frequency-domain position without the need for adjustment of the RF processing parameter.

In some possible embodiments, the UE receives, in a secondary cell, the wake up signal based on the subcarrier spacing, where the frequency-domain position corresponding to the wake up signal is a frequency-domain position corresponding to a first active BWP. Optionally, the first active BWP is a terminology used for indicating a default active BWP in the secondary cell. This enables the UE 102 in the RRC connected state in the secondary cell, after receiving the downlink information at the frequency-domain position corresponding to the first active BWP, to continue to receive the wake up signal by using this frequency-domain position without the need for adjustment of the RF processing parameter.

In some possible embodiments, a center location of the frequency-domain position corresponding to the wake up signal may be a center location of a frequency-domain position corresponding to the synchronizing signal block, or a center location of a frequency-domain position corresponding to a control resource set CORESET #0.

Optionally, the center location of the frequency-domain position corresponding to the wake up signal may be a center location of a frequency-domain position corresponding to the synchronizing signal block. This enables the UE 102, after receiving the synchronizing signal block and performing the synchronization, to directly determine the center location of the frequency-domain position corresponding to the wake up signal, without the need for adjustment of the RF processing parameter, thereby facilitating the UE to receive the wake up signal subsequently.

In some possible embodiments, the center location of the frequency-domain position corresponding to the wake up signal may be a center location of a frequency-domain position corresponding to a control resource set CORESET #0. This enables the UE 102, after receiving the DCI in CORESET #0, to directly determine the center location of the frequency-domain position corresponding to the wake up signal, without the need for adjustment of the RF processing parameter, thereby facilitating the UE to receive the wake up signal subsequently.

In some embodiments, an end location of a frequency-domain position corresponding to the wake up signal may be provided with a frequency-domain guard interval. In some embodiments, the end location of the frequency-domain position includes a location corresponding to the highest frequency in the frequency-domain position, and a location corresponding to the lowest frequency in the frequency-domain position.

At step S302, the network device 101 sends to the UE 102, at the frequency-domain position, the wake up signal based on a subcarrier spacing.

The subcarrier spacing corresponding to the wake up signal sent by the network device 101 to the UE 102 is a subcarrier spacing of an SS/PBCH block. The UE 102 receives the wake up signal based on the subcarrier spacing.

The UE 102 receives, at the frequency-domain position, the wake up signal based on the subcarrier spacing.

According to the embodiment provided in the present application, after receiving the synchronizing signal block and performing the synchronization, the UE 102 can receive, at the frequency-domain position configured by the network device, the wake up signal based on the subcarrier spacing of the synchronizing signal block; without the need for adjustment of the baseband parameter and the need for adjustment of the RF parameter, the UE 102 can directly receive the wake up signal at the frequency-domain position by using the baseband parameter corresponding to the subcarrier spacing. This can effectively reduce the complexity of receiving the wake up signal by the UE, and save the UE's power consumption.

In some possible embodiments, before step S301, the method further includes: obtaining the frequency-domain guard interval based on agreement of protocol.

In some possible embodiments, the frequency-domain guard interval may be configured by the network device 102 for the UE.

In an example, as shown in FIG. 4, between step S301 and step S302, the method further includes step S301′, where the network device 101 sends indication information, and the UE 102 receives the indication information sent by the network device. In this embodiment, the indication information is used for indicating the frequency-domain guard interval. That is, the network device sends the configuration information to the UE 102 before sending the indication information to the UE 102.

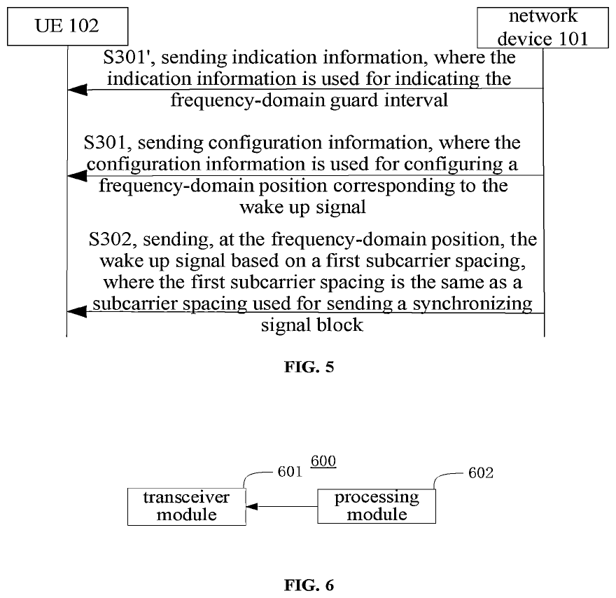

In another example, as shown in FIG. 5, step S301′ precedes step S301, i.e., the network device first sends the indication information to the UE 102, and then sends the configuration information to the UE 102.

In another example, the network device 101 may send the configuration information and the indication information at the same time, i.e., send the configuration information and the indication information in the same signaling.

The embodiments of the present disclosure provide a method for transmitting a wake up signal. The method includes: sending, by a network device 101 based on a subcarrier spacing, the wake up signal to a UE, where the subcarrier spacing is a subcarrier spacing of a synchronizing signal block; and receiving, by the UE 102 at a preset frequency-domain position, the wake up signal based on the subcarrier spacing when the UE determines that it does not receive from the network device configuration information used for configuring the frequency-domain position corresponding to the wake up signal.

In some possible embodiments, the preset frequency-domain position is a preset default frequency-domain position that is stored by the UE 102, or a fixed frequency-domain position obtained by the UE 102 based on agreement of protocol.

The subcarrier spacing of the wake up signal in the embodiment of the present disclosure is the subcarrier spacing of the synchronizing signal block.

When the network device needs to send a wake up signal to the UE, the network device sends the wake up signal to the UE based on this subcarrier spacing, and the UE receives, based on this subcarrier spacing, the wake up signal sent by the network device. That is, there is no need to negotiate which subcarrier spacing to use for transmitting the wake up signal between the network device and the UE, and they both can use the subcarrier spacing agreed in the protocol separately.

For example, if the subcarrier spacing agreed in the protocol for sending the wake up signal to the UE is 15 KHz, the network device sends the wake up signal to the UE 102 by using 15 KHz, and the UE 102 receives, by using 15 KHz, the wake up signal sent from the network device 101.

According to the same idea as the above method embodiments, the embodiments of the present disclosure also provide a communication device. The communication device may have the function of the UE 102 in the above method embodiments, and be configured to perform the steps performed by the UE 102 provided in the above embodiments. The function may be implemented by hardware, or implemented by software or by hardware executing corresponding software. The hardware or software includes one or more modules corresponding to the above-described function.

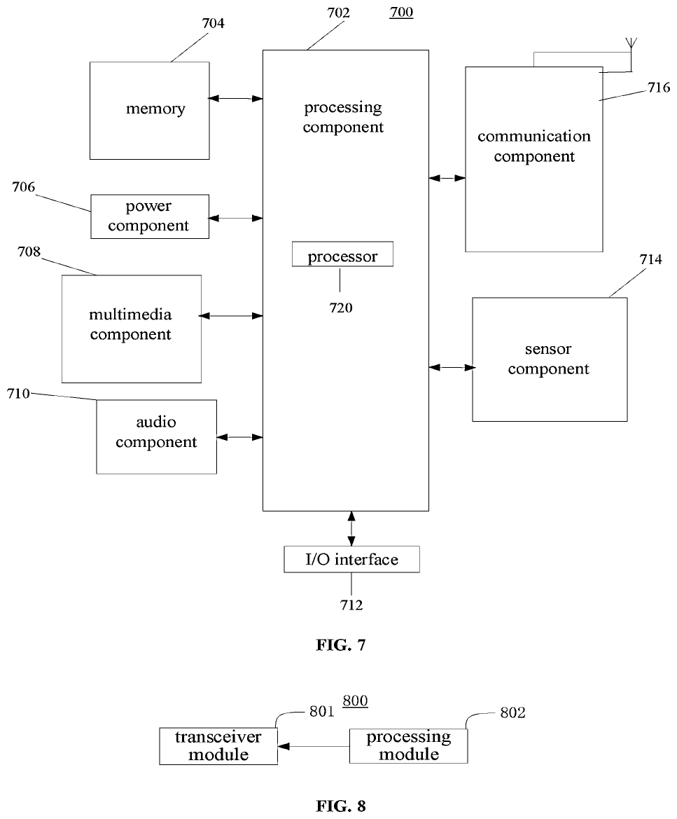

In a possible implementation, the communication device 600 as shown in FIG. 6 may serve as the UE 102 involved in the above method embodiments and perform the steps performed by the UE 102 in the above method embodiments. As shown in FIG. 6, the communication device 600 may include a transceiver module 601 and a processing module 602, and the transceiver module 601 and the processing module 602 are coupled to each other. The transceiver module 601 may be configured to support the communication device 600 in communicating, and the transceiver module 601 may have wireless communication capabilities, such as being capable of communicating wirelessly with other communication devices via a wireless air interface. The processing module 602 may be configured to support the communication device 600 in performing the processing actions in the above method embodiments, including, but not limited to, generating information or messages sent by the transceiver module 601, and/or, demodulating and decoding signals received by the transceiver module 601, etc.

In performing the steps implemented by the UE 102, the transceiver module 601 is configured to receive a wake up signal based on a subcarrier spacing, where the subcarrier spacing is a subcarrier spacing of a synchronizing signal block.

In some possible embodiments, the processing module 602 is configured to obtain the subcarrier spacing based on agreement of protocol.

In some possible embodiments, the transceiver module 601 is configured to receive configuration information sent by a network device, where the configuration information is used for configuring a frequency-domain position corresponding to the wake up signal, and the transceiver module 601 is further configured to receive, at the frequency-domain position, the wake up signal based on the subcarrier spacing.

In some possible embodiments, the frequency-domain position corresponding to the wake up signal is one of:
a frequency-domain position corresponding to the synchronizing signal block;
a frequency-domain position corresponding to a control resource set CORESET #0;
a frequency-domain position corresponding to an initial bandwidth part; and
all or part of frequency-domain positions corresponding to an active bandwidth part.

In some possible embodiments, a center location of the frequency-domain position corresponding to the wake up signal is one of:
a center location of a frequency-domain position corresponding to the synchronizing signal block; and
a center location of a frequency-domain position corresponding to a control resource set CORESET #0.

In some possible embodiments, the transceiver module 601 is further configured to receive, in a secondary cell, the wake up signal based on the subcarrier spacing, where the frequency-domain position corresponding to the wake up signal is a frequency-domain position corresponding to a first active bandwidth part.

In some possible embodiments, an end location of a frequency-domain position corresponding to the wake up signal is provided with a frequency-domain guard interval.

In some possible embodiments, the processing module 602 is further configured to obtain the frequency-domain guard interval based on agreement of protocol.

In some possible embodiments, the transceiver module 601 is further configured to receive indication information sent by a network device, where the indication information is used for indicating the frequency-domain guard interval.

When the communication device is a UE, its structure may also be shown by the device 700. For example, the device 700 may be a cell phone, a computer, a digital broadcast terminal, a message transceiver device, a game console, a tablet device, a medical device, a fitness device, or a personal digital assistant.

Referring to FIG. 7, the device 700 may include one or more of the following components: a processing component 702, a memory 704, a power component 706, a multimedia component 708, an audio component 710, an input/output (I/O)) interface 712, a sensor component 714, and a communication component 716.

The processing component 702 generally controls overall operation of the device 700, such as operations associated with display, telephone calls, data communication, camera operations, and recording operations. The processing component 702 may include one or more processors 720 to execute an instruction, thereby completing all or some of the steps of the methods described above. In addition, the processing component 702 may include one or more modules that facilitate interaction between the processing component 702 and other components. For example, the processing component 702 may include a multimedia module to facilitate interaction between the multimedia component 708 and the processing component 702.

The memory 704 is configured to store various types of data to support operations at the device 700. Examples of such data include the following for any application program or method operated on the device 700: instructions, contact data, phonebook data, messages, pictures, videos, etc. The memory 704 may be implemented by any type of volatile or non-volatile storage device or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a disk, or a CD-ROM.

The power component 706 supplies power to various components of the device 700. The power component 706 may include a power supply management system, one or more power supplies, and other components associated with generating, managing and distributing power for the device 700.

The multimedia component 708 includes a screen that provides an output interface between the device 700 and a user. In some embodiments, the screen may include a liquid crystal display (LCD) and a touch panel (TP). If the screen includes a touch panel, the screen may be implemented as a touch screen to receive input signals from the user. The touch panel includes one or more touch sensors to sense touches, swipes, and gestures on the touch panel. The touch sensor may not only sense the boundaries of the touch or swipe action, but also detect the duration and pressure associated with the touch or swipe operation. In some embodiments, the multimedia component 708 includes a front-facing camera and/or a rear-facing camera. The front-facing camera and/or the rear-facing camera may receive external multimedia data when the device 700 is in an operating mode, such as a shooting mode or a video mode. Each of the front-facing camera and the rear-facing camera may be a fixed optical lens system or have a focal length and optical zoom capability.

The audio component 710 is configured to output and/or input audio signals. For example, the audio component 710 includes a microphone (MIC), configured to receive external audio signals when the device 700 is in an operating mode, such as a calling mode, a recording mode and a voice recognition mode. The received audio signals may be further stored in the memory 704 or sent via the communication component 716. In some embodiments, the audio component 710 further includes a speaker for outputting the audio signals.

The I/O interface 712 provides an interface between the processing component 702 and a peripheral interface module, and the peripheral interface module may be a keypad, a click wheel, a button, etc. These buttons may include, but are not limited to, a home button, a volume button, a start button, and a lock button.

The sensor component 714 includes one or more sensors configured to provide status assessment of various aspects of the device 700. For example, the sensor component 714 may detect an open/closed state of the device 700, relative positioning of the components, for example, the components are the display and small keypad of the device 700, the sensor component 714 may also detect a change in the position of the device 400 or a change in the position of one component of the device 700, the presence or absence of user contact with the device 700, the orientation or acceleration/deceleration of the device 700, and temperature changes of the device 700. The sensor component 714 may include a proximity sensor that is configured to detect the presence of nearby objects in the absence of any physical contact. The sensor component 714 may also include a light sensor, such as a CMOS or CCD image sensor, for use in imaging applications. In some embodiments, the sensor component 714 may also include an accelerometer sensor, a gyroscope sensor, a magnetic sensor, a pressure sensor, or a temperature sensor.

The communication component 716 is configured to facilitate the communication between the device 700 and other devices by wired or wireless means. The device 700 may access a wireless network based on a communication standard, such as WiFi, 4G, 5G, or a combination thereof. In an exemplary embodiment, the communication component 716 receives broadcast signals or broadcast-related information from an external broadcast management system via a broadcast channel. In an exemplary embodiment, the communication component 716 further includes a near-field communication (NFC) module to facilitate short-range communication. For example, the NFC module may be implemented based on the radio frequency identification (RFID) technology, infrared data association (IrDA) technology, ultra-wideband (UWB) technology, Bluetooth (BT) technology, and the like.

In an exemplary embodiment, the device 700 may be implemented by one or more of: an application-specific integrated circuit (ASIC), a digital signal processor (DSP), a digital signal processing device (DSPD), a programmable logic device (PLD), a field-programmable gate array (FPGA), a controller, a microcontroller, a microprocessor, or other electronic elements, to perform the above methods.

In an exemplary embodiment, a non-transitory computer-readable storage medium including an instruction is also provided, such as the memory 704 including an instruction. The instruction described above is capable of being executed by the processor 720 of the device 700 to complete the above methods. For example, the non-transitory computer-readable storage medium may be an ROM, a random access memory (RAM), a CD-ROM, a magnetic tape, a floppy disk, or an optical data storage verification device, etc.

According to the same idea as the above method embodiments, the embodiments of the present disclosure also provide a communication device. The communication device may have the function of the network device 101 in the above method embodiments, and be configured to perform the steps performed by the network device 101 provided in the above embodiments. The function may be implemented by hardware, or implemented by software or by hardware executing corresponding software. The hardware or software includes one or more modules corresponding to the above-described function.

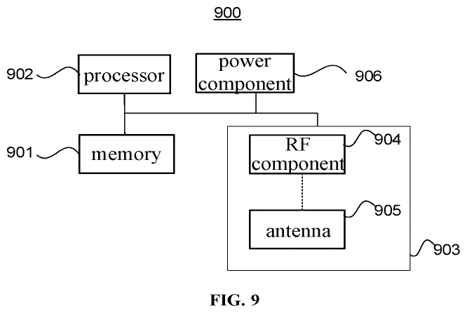

In a possible implementation, the communication device 800 as shown in FIG. 8 may serve as the network device 101 involved in the above method embodiments and perform the steps performed by the network device 101 in the above method embodiments. As shown in FIG. 8, the communication device 800 may include a transceiver module 801 and a processing module 802, and the transceiver module 801 and the processing module 802 are coupled to each other. The transceiver module 801 may be configured to support the communication device 800 in communicating, and the transceiver module 801 may have wireless communication capabilities, such as being capable of communicating wirelessly with other communication devices via a wireless air interface. The processing module 802 may be configured to support the communication device 800 in performing the processing actions in the above method embodiments, including, but not limited to, generating information or messages sent by the transceiver module 801, and/or, demodulating and decoding signals received by the transceiver module 801, etc.

In performing the steps implemented by the network device 101, the transceiver module 801 is configured to send, based on a subcarrier spacing, the wake up signal, where the subcarrier spacing is a subcarrier spacing of a synchronizing signal block.

In some possible embodiments, the processing module 802 may be configured to obtain the subcarrier spacing based on agreement of protocol.

In some possible embodiments, the transceiver module 801 may be further configured to send configuration information to the UE, where the configuration information is used for configuring a frequency-domain position corresponding to the wake up signal; and the transceiver module 801 may be further configured to send to the UE, at the frequency-domain position, the wake up signal based on the subcarrier spacing.

In some possible embodiments, the frequency-domain position corresponding to the wake up signal is one of:
a frequency-domain position corresponding to the synchronizing signal block;
a frequency-domain position corresponding to a control resource set CORESET #0;
a frequency-domain position corresponding to an initial bandwidth part; and
all or part of frequency-domain positions corresponding to an active bandwidth part.

In some possible embodiments, a center location of the frequency-domain position corresponding to the wake up signal is one of:
a center location of a frequency-domain position corresponding to the synchronizing signal block; and
a center location of a frequency-domain position corresponding to a control resource set CORESET #0.

In some possible embodiments, the transceiver module 801 is further configured to send, in a secondary cell, the wake up signal based on the subcarrier spacing, where the frequency-domain position corresponding to the wake up signal is a frequency-domain position corresponding to a first active bandwidth part.

In some possible embodiments, an end location of a frequency-domain position corresponding to the wake up signal is provided with a frequency-domain guard interval.

In some possible embodiments, the processing module 802 is further configured to obtain the frequency-domain guard interval based on agreement of protocol.

In some possible embodiments, the transceiver module 801 is further configured to send indication information to the UE, where the indication information is used for indicating the frequency-domain guard interval.

When the communication device is a network device, its structure may also be shown in FIG. 9. The structure of the communication device is illustrated by taking an example of the network device 101 being a base station. As shown in FIG. 9, the device 900 includes a memory 901, a processor 902, a transceiver component 903, and a power component 906. The memory 901 is coupled to the processor 902, and may be configured to save programs and data necessary for the communication device 900 to implement various functions. The processor 902 is configured to support the communication device 900 in performing the corresponding function in the above methods, and this function may be implemented by calling a program stored in the memory 901. The transceiver component 903 may be a wireless transceiver that may be configured to support the communication device 900 in performing, via a wireless air interface, receiving signaling and/or data, and sending signaling and/or data. The transceiver component 903 may also be referred to as a transceiver unit or a communication unit, and the transceiver component 903 may include an RF component 904 and one or more antennas 905, where the RF component 904 may be a remote radio unit (RRU), which may be specifically configured for transmission of RF signals and conversion between RF signals and baseband signals, and the one or more antennas 905 may be specifically configured to perform radiation and reception of RF signals.

When the communication device 900 needs to send data, the processor 902, after performing baseband processing on the data to be sent, may output a baseband signal to an RF unit, and the RF unit, after performing RF processing on the baseband signal, sends the RF signal in the form of electromagnetic waves through the antenna. When there is data sent to the communication device 900, the RF unit receives an RF signal through the antenna, converts the RF signal to a baseband signal, and outputs the baseband signal to the processor 902, and the processor 902 converts the baseband signal to data and processes the data.

After considering the specification and practicing the invention disclosed herein, those skilled in the art will easily come up with other implementation solutions of the embodiments of the present disclosure. The present application is intended to cover any variations, uses or adaptive changes of the embodiments of the present disclosure, and the variations, uses or adaptive changes follow the general principles of the embodiments of the present disclosure and include common knowledge or commonly used technical means in the art that are not disclosed in the present disclosure. The specification and embodiments are only considered to be exemplary, and the true scope and spirit of the embodiments of the present disclosure are indicated by the following claims.

It should be understood that the embodiments of the present disclosure are not limited to the precise structure which has been described above and illustrated in the accompanying drawings, and that various modifications and alterations may be made without departing from the scope of the embodiments of the present disclosure. The scope of the embodiments of the present disclosure is limited only by the appended claims.

### INDUSTRIAL APPLICABILITY

The UE receives the wake up signal based on the subcarrier spacing, and the subcarrier spacing is the subcarrier spacing of the synchronizing signal block, enabling the UE, after receiving, by using the subcarrier spacing corresponding to the synchronizing signal block, the synchronizing signal block and completing synchronization, to continue to receive or process the wake up signal by using the baseband parameter corresponding to this subcarrier spacing, without the need for software or hardware adjustment to change the baseband parameter, thereby effectively reducing the processing complexity of receiving the wake up signal by the UE, and saving the UE's power consumption.

What is claimed is:

1. A method for receiving a wake up signal, performed by a user equipment (UE), wherein the method comprises:
receiving the wake up signal based on a subcarrier spacing, wherein the subcarrier spacing is a subcarrier spacing of a synchronizing signal block.

2. The method according to claim 1, further comprising:
obtaining the subcarrier spacing based on agreement of protocol.

3. The method according to claim 1 or 2, further comprising:
receiving configuration information sent by a network device, wherein the configuration information is used for configuring a frequency-domain position corresponding to the wake up signal;
wherein the receiving the wake up signal based on the subcarrier spacing comprises:
receiving, at the frequency-domain position, the wake up signal based on the subcarrier spacing.

4. The method according to claim 3, wherein the frequency-domain position corresponding to the wake up signal is one of:
a frequency-domain position corresponding to the synchronizing signal block;
a frequency-domain position corresponding to a control resource set CORESET #0;
a frequency-domain position corresponding to an initial bandwidth part; and
all or part of frequency-domain positions corresponding to an active bandwidth part.

5. The method according to claim 3, wherein a center location of the frequency-domain position corresponding to the wake up signal is one of:
a center location of a frequency-domain position corresponding to the synchronizing signal block; and
a center location of a frequency-domain position corresponding to a control resource set CORESET #0.

6. The method according to claim 3, wherein the receiving the wake up signal based on the subcarrier spacing comprises:
receiving, in a secondary cell, the wake up signal based on the subcarrier spacing, wherein the frequency-domain position corresponding to the wake up signal is a frequency-domain position corresponding to a first active bandwidth part.

7. The method according to any one of claims 1 to 6, wherein an end location of a frequency-domain position corresponding to the wake up signal is provided with a frequency-domain guard interval.

8. The method according to claim 7, further comprising:
obtaining the frequency-domain guard interval based on agreement of protocol.

9. The method according to claim 7, further comprising:
receiving indication information sent by a network device, wherein the indication information is used for indicating the frequency-domain guard interval.

10. A method for sending a wake up signal, performed by a network device, wherein the method comprises:
sending, based on a subcarrier spacing, the wake up signal to a user equipment (UE), wherein the subcarrier spacing is a subcarrier spacing of a synchronizing signal block.

11. The method according to claim 10, further comprising:
obtaining the subcarrier spacing based on agreement of protocol.

12. The method according to claim 10 or 11, further comprising:
sending configuration information to the UE, wherein the configuration information is used for configuring a frequency-domain position corresponding to the wake up signal;
wherein the sending, based on the subcarrier spacing, the wake up signal to the UE comprises:
sending to the UE, at the frequency-domain position, the wake up signal based on the subcarrier spacing.

13. The method according to claim 12, wherein the frequency-domain position corresponding to the wake up signal is one of:
a frequency-domain position corresponding to the synchronizing signal block;
a frequency-domain position corresponding to a control resource set CORESET #0;
a frequency-domain position corresponding to an initial bandwidth part; and
all or part of frequency-domain positions corresponding to an active bandwidth part.

14. The method according to claim 12, wherein a center location of the frequency-domain position corresponding to the wake up signal is one of:
a center location of a frequency-domain position corresponding to the synchronizing signal block; and
a center location of a frequency-domain position corresponding to a control resource set CORESET #0.

15. The method according to claim 13, wherein the sending the wake up signal based on the subcarrier spacing comprises:
sending, in a secondary cell, the wake up signal based on the subcarrier spacing, wherein the frequency-domain position corresponding to the wake up signal is a frequency-domain position corresponding to a first active bandwidth part.

16. The method according to any one of claims 10 to 15, wherein an end location of a frequency-domain position corresponding to the wake up signal is provided with a frequency-domain guard interval.

17. The method according to claim 16, further comprising:
obtaining the frequency-domain guard interval based on agreement of protocol.

18. The method according to claim 16, further comprising:
sending indication information to the UE, wherein the indication information is used for indicating the frequency-domain guard interval.

19. An apparatus for receiving a wake up signal, comprising:
a transceiver module, configured to receive the wake up signal based on a subcarrier spacing, wherein the subcarrier spacing is a subcarrier spacing of a synchronizing signal block.

20. An apparatus for sending a wake up signal, comprising:
a transceiver module, configured to send the wake up signal based on a subcarrier spacing, wherein the subcarrier spacing is a subcarrier spacing of a synchronizing signal block.

21. A communication device, comprising a processor and a memory, wherein
the memory is configured to store a computer program; and
the processor is configured to execute the computer program, thereby implementing the method according to any one of claims 1-9.

22. A communication device, comprising a processor and a memory, wherein
the memory is configured to store a computer program; and
the processor is configured to execute the computer program, thereby implementing the method according to any one of claims 10-18.

23. A computer-readable storage medium, wherein the computer-readable storage medium stores an instruction, and the instruction, when invoked and executed on a computer, enables the computer to perform the method according to any one of claims 1-9.

24. A computer-readable storage medium, wherein the computer-readable storage medium stores an instruction, and the instruction, when invoked and executed on a computer, enables the computer to perform the method according to any one of claims 10-18.
